(19) United States
(12) Patent Application Publication
(10) Pub. No.: US 2008/0162344 A1
(43) Pub. Date: Jul. 3, 2008

(54) METHOD AND SYSTEM FOR ENTERPRISE SOFTWARE HAVING DIRECT DEBIT MANDATES

(75) Inventor: Karsten EGETOFT, Walldorf (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/618,474

(22) Filed: Dec. 29, 2006

(51) Int. Cl. G06Q 20/00

(52) U.S. Cl. 705/44

(57) ABSTRACT

A system and method for providing a financial software system to various actors in the financial supply chain to facilitate transactions and communications. Specifically, direct debit mandates may be modeled as a business or process object with generic services that can be consumed from other applications deployed at various actors supporting different processing steps in the financial supply chain. Such can be compatible with both the debtor and creditor systems allowing for payments and collections to take place without undue work, time loss, or expense.

### BACKGROUND

In order to support an end-to-end financial supply chain various computer systems located with various actors come into use. There are typically systems which are used by companies, and then there is are completely different systems used by the banks, who are involved in the financial transaction of moving money from one account to another. The various actors in the financial supply chain are using different systems which are sometimes incompatible due to the lack of standardized methods and schemes that defines the business semantic of common business objects in one or more different systems that are processing part of the financial value chain for the same financial transaction. This can hamper business activity. For example, the mappings between the two or more different systems may cause the lost of valuable information and sometimes the mappings create errors. If one actor in the financial supply chain introduce a new software, mappings and interface relationships with the other systems used by other actors need to be built or adapted between the systems, creating not only a time delay but also monetary expense.

In some countries, there is payment product called direct debits. In order to allow a creditor to draw money from an account of a debtor the debtor signs a direct debit mandate that must be kept by the creditor as documentation for the creditors right to draw money from the debtor's account via a direct debit payment order. Here, a mandate is the authorization or expression of consent given by the debtor to the creditor to allow the creditor to initiate collections for debiting the specific Debtor's account and to allow the Debtor bank to comply with such instructions A mandate may exist in paper-based form signed by the debtor or as an electronic document which is created and signed in a secure electronic manner. The mandate should be transmitted to the creditor bank with each direct debit or with a collection of direct debits. A debtor may request that the bank refund a payment made through a direct debit transaction, and the debtor can request his bank not to accept direct debits from a certain creditor or a debtor may even request that the bank completely prohibit the bank from debiting his account for any direct debit from any creditor. A direct debit transaction can be a one-off or a recurrent direct debit. A creditor with a signed mandate for a one-off direct debit is only allowed to debit the debtors account once. In addition a creditor may generate subsequent direct debit collections in line with the mandate for a recurrent direct debit. If a creditor does not present a collection under a given valid mandate for a given period of, for example, 18 months starting from the date of the latest collection presented, the creditor must cancel the mandate and is no longer allowed to initiate collections based on this canceled mandate. Such a new schema involving so many activities needs to be implemented in both the banking and customer/company enterprise resource planning (ERP) systems. However, an implementation of the above schema will show that a high degree of common functionality can be implemented to support both the accounts payable systems (ERP) of the creditor and the banking systems of the bank of the debtor.

### BRIEF DESCRIPTION OF THE DRAWINGS

FIG. 1 illustrates a direct debit scheme in accordance with an embodiment of the present invention.

FIG. 2 illustrates enterprise services for direct debit mandates in accordance with an embodiment of the present invention.

FIG. 3 illustrates an example creditor's business scenario in accordance with an embodiment of the present invention.

FIG. 4 illustrates an example debtor's business scenario in accordance with an embodiment of the present invention.

### DETAILED DESCRIPTION

Embodiments of the present invention include a method, a system, and an apparatus to implement a generic direct debit mandate software component. Further embodiments of the present invention provide for a generic direct debit mandate software component which can be used across business scenarios within both the banking and corporate ERP systems.

Embodiments of the present invention provide for a method to implement a software based service that can offer all the needed services for both corporate business scenarios and business scenarios within banks.

Embodiments of the present invention provide a system for reuse of functionality across business processes from both ERP systems and core banking applications. Embodiments of the present invention provide a system for enhanced functionality for all applications consuming the enterprise services offered for the direct debit mandate administration. Embodiments of the present invention provide a software component offering direct debit mandate enterprise services to other applications. Users may consume services from within other business processes and in-house applications. Embodiments of the present invention provide for major cost reduction for implementation and maintenance of the multiple software components due to the reuse of the generic software component for direct debit mandate administration.

Embodiments of the present invention may be used within various different business applications, e.g. enterprise resource planning applications and core banking applications, e.g., payment processing, loans processing and account processing.

Embodiments of the present invention provide for a cost reduction in the implementation and maintenance of the software components due to the reuse of the generic software component.

In an exemplary embodiment a leasing company and the bank of the customer of the leasing company both use the generic software component as provided herein. The leasing company (the creditor) wants to debit its customer once a month for the leasing rate. In order to do this it keeps information about the direct debit mandate signed by the customer in one or more business or process objects linked to the leasing contract with the customer. The bank of the leasing customer (the debtor) has the same business or process object in their core banking system linked to the account of the leasing customer. Whenever the leasing company triggers a direct debit to be debited to the account of their customer the bank servicing this account validates this transaction against the direct debit mandate information linked to the account within the core banking system. The generic implementation of the direct debit mandate business object allow both the system of the leasing company (ERP system) and the core banking system of the bank to use the same business object and common services offered by this business object. Thus, when information concerning direct debit mandates is sent between the leasing company and the bank, the information associated with the mandate business object is also sent and updated. Accordingly, a large mapping between the systems is not needed, as it would otherwise with other systems. A customer and a financial entity are both provided with less cost and more benefits since they can enjoy more services due to compatibility, and less time and cost consumption since no large mapping is needed.

Generally, a bank or lending entity and another entity, e.g., a company, will employ different software to process financial transactions. For example, a corporate entity will use an enterprise resource planning software. A bank oftentimes will develop its own software in-house to process payment transactions on behalf of customers However, each side's software will tend to have some overlapping functionality.

In embodiments of the present invention, a creditor may prepare a direct debit mandate and store/save/record/maintain the direct debit mandate (as yet unsigned) as a software object in a memory. The creditor then may send the prefilled direct debit mandate—or even, an unfilled in direct debit mandate—to a debtor for signature. The debtor then sends back the signed direct debit mandate to the creditor who updates the mandate business object with the information on the signature. The creditor can now initiate direct debiting of the debtor's bank account. When initiating a direct debit according to the signed mandate the creditor then send the direct debit mandate information to the creditor's bank to carry out debiting instructions. The creditor's bank then communicates with the debtors bank with the direct debit mandate to obtain the desired funds. The debtor's bank may contact the debtor for confirmation that such a debit is valid, or to notice the debtor that a certain amount of funds will be and/or has been withdrawn from the debtor's bank account.

In embodiments of the present invention, the direct debit mandate may be a “one-off,” i.e., one time occurrence, or recurring debiting of a debtor's account.

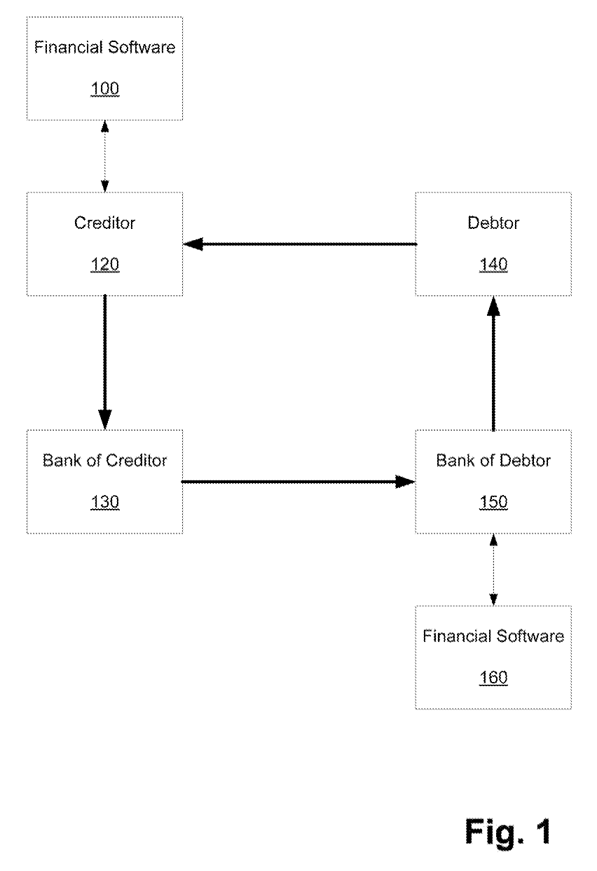

FIG. 1 illustrates a direct debit scheme which is supported by the present invention. A creditor 120, e.g., a lending entity, uses the financial software 100 including the present invention. The creditor receives at least one signed mandate from a debtor 140. The creditor 120 then initiates the direct debit with the creditor's bank 130. The creditor's bank 130 then collects the direct debit from the debtor's bank 150 by passing on the mandate information to the debtor's bank. The debtor's bank uses the financial software 160 including the present invention. The debtor's bank 150 then will match the mandate information passed from the creditors bank with the information on direct debit mandate stored within the financial software 160 in order to check validity of the direct debit collection. The debtors bank can also inform the debtor 140 about the upcoming direct debit transaction. Such communications between the banks and all four entities in the financial supply chain in the example require information about the direct debit mandate to be maintained and stored within various software applications located with the four main entities involved. Further, in such a situation, a creditor typically would use a software application to manage the creditor's accounts receivable processes as part of an ERP application, and to maintain the new direct debit mandate. The debtor's bank also needs to maintain the direct debit mandate that: the debtor signed in order to offer services to the debtor Accordingly, due to these requirements, any typical implementation means that any software application affected by the implementation of the direct debit mandates would implement them as a part of the specific application and processing of the financial supply chain. However, this means that additional mapping between existing systems would need to take place due to this additional information to maintain. Instead, use of the present invention provides a method to implement a generic software application for direct debit mandate administration which is based on a common business objects and various services that will support all scenarios within ERP applications and within core banking applications. Implementing the present invention will reduce the required mappings between business objects maintained within various systems and applications deployed with the various actors in the financial supply chain.

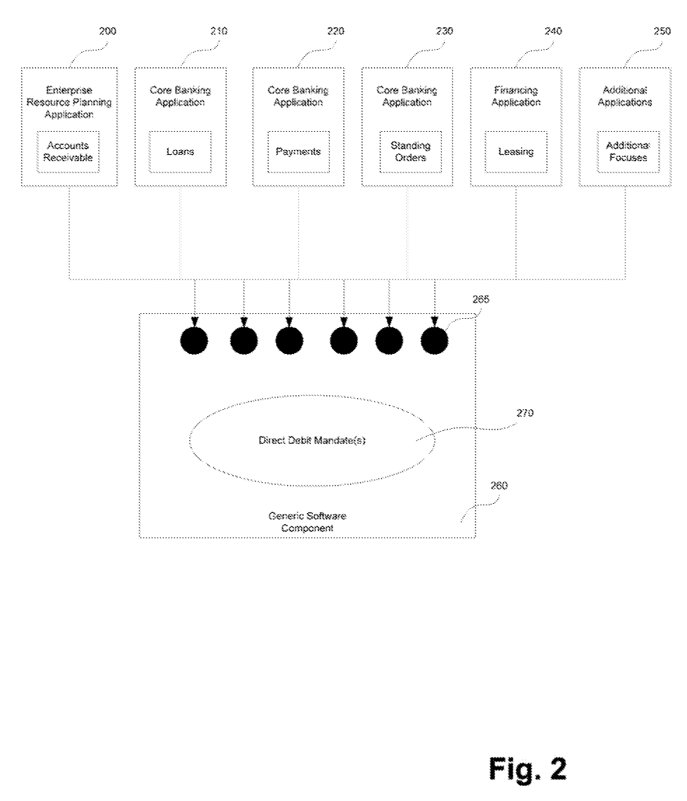

FIG. 2 illustrates the consumer applications requesting enterprise services for direct debit mandates according to an embodiment of the present invention. These consumer applications can be used in different business scenarios. For example, the consumer applications may include an enterprise resource planning application for accounts receivable 200, a core banking application for loans 210, a core banking application for standing orders 230; financing application for leasing 240, etc. These are just some of the many different consumer applications that can be applied here, not only in the financial supply chain area, but also in other areas. The enterprise services 265 provides the business functions offered by the direct debit mandates business object 270 implemented in the generic software component 260. The enterprise services 265 are consumed by the different applications 200-250 which are deployed within different computer systems supporting different processing steps of the financial supply chain,

Examples of enterprise services 265 provided by the generic software component 260 include:

Create new mandate (signed or unsigned)

Print mandate (pdf, E-mail, paper, fax)

Change/amend mandate

Cancel/inactvate mandate

Read/search for mandate

Assign digital signature to mandate

Assign paper image of paper based mandate

Archive mandate

Block mandate

Delete mandate

Trigger correspondence to debtor about new mandates

Update status of mandate after a given period of inactivity

Validate direct debit payment order against mandate, etc.

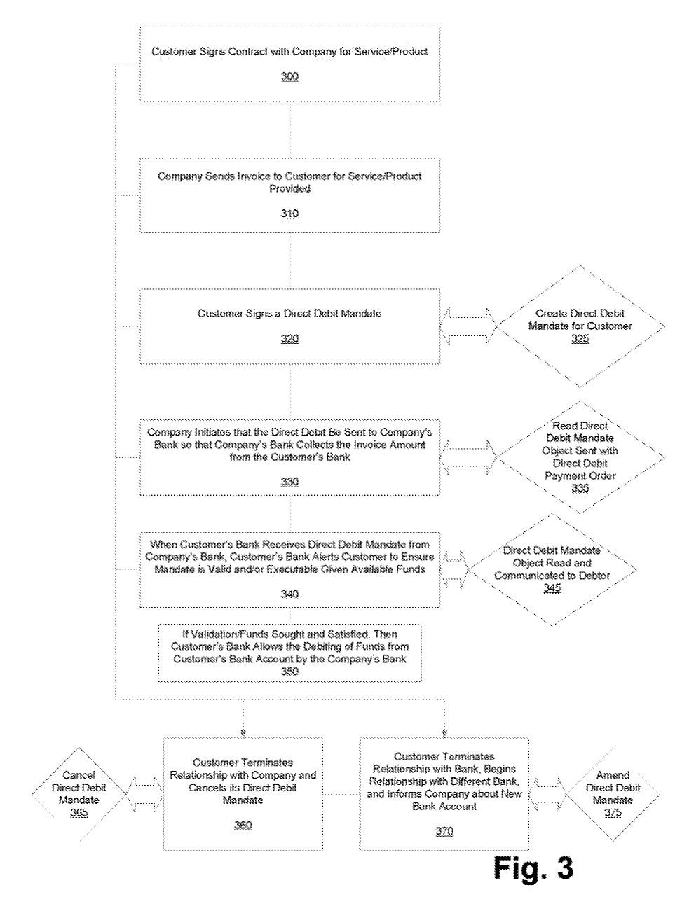

FIG. 3 illustrates several business scenarios from the creditor end of a direct debit scheme which are supported by the present invention. A customer may sign a contract with a company to get a service, e.g. utilities services, construction services, consulting services, etc. 300. The company then sends an invoice to the customer 310. To pay the invoice, the customer signs a direct debit mandate 320. Thus, the financial software application of the company (ERP system) must maintain the direct debit mandate business object 325. The company then can collect the invoice amount from the customer's bank account via a direct debit. The company may, for example, initiate that the direct debit be sent to their house bank so that the creditor's house bank collects the invoice amount from the customer's bank 330 (bank of the debtor). Thus, the financial software must read the direct debit mandate object to be sent with the direct debit payment order 335. When the customer's bank received the direct debit mandate from the company's bank, the customer's bank may alert or communicate the mandate receipt to the customer 340. The customer's bank may communicate with the customer for purposes of validation of the mandate and/or notice that funds will be debited and/or available funds are lacking to fulfill the mandate, among various notices. The bank's financial software reads the direct debit mandate object, and effects a communication regarding same with the customer 345. If the validation and/or funds sought are satisfied, then the customer's bank may allow the debiting of funds from the customer's bank account (as provided by the mandate information) by the company's bank 350. A customer may later decide to terminate its relationship with the company, and cancel the customer's direct debit mandate with that company 360. Thus, the financial software of the company must cancel the direct debit mandate 365. Alternatively, a customer may just be terminating his relationship with his bank, and informs the company of his new bank account 370. Thus, the financial software of the company must amend the direct debit mandate with the new information of the debtor 375. Of course, many other services are available to use in the context of the present invention. The figures described herein are not meant to limit the present invention, but instead provide illustrative examples.

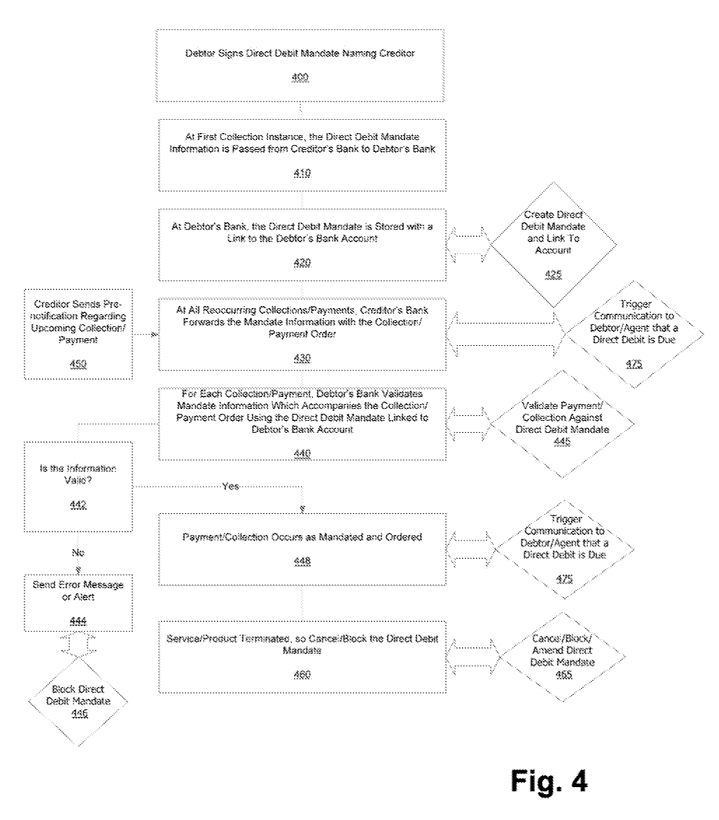

FIG. 4 illustrates several business scenarios from the debtor end, e.g., by the bank of the debtor, of a direct debit scheme which are supported by the present invention. An account holder (debtor) at a bank signs a direct debit mandate naming a creditor company 400. At the first collection instance under the direct debit mandate, the mandate information is passed from the creditor's bank to the debtor's bank 410. At the debtor's bank, the mandate is stored as a new mandate object with a link to the account of the debtor 420. Thus, the financial software must create a direct debit mandate for the bank account holder 425.

At all reoccurring collections, the creditor's bank forwards the mandate information with the collection or payment order 430. For each collection, the debtor's bank validates the mandate information coming with the collection or payment order against the direct debit mandate linked to the account 440. The validation is done in order to see if the direct debit mandate is not locked or canceled by the debtor. Thus, the financial software must validate payment/collection against the direct debit mandate 445. Upon validating the information 442, if the information on the direct debit is found not valid, then an alert may be sent to the debtor, and/or the direct debit can be rejected by the debtors bank or some other correspondence/communication may be sent to any of the various parties involved 444. Also, the payment/collection is blocked from occurring 446. If the information is found valid, then the payment/collection occurs as mandated and ordered 448 and the amount ordered are debited to the debtors account.

The debtor may receive a pre-notification from the creditor company that the direct debit collection will occur again in 2 weeks 450. However, if the debtor is no longer receiving services from the creditor company, the debtor may wish to refuse further payments and ask his bank to block the direct debit mandate if the prenotified collection is executed 460. Thus, the financial software of the bank of the debtor must block the direct debit mandates either automatically, based on predefined rule(s), or manually (e.g., upon request) 465.

If, for example, the debtor's bank received a direct debit collection five days before the due date, a message or alert or correspondence may be manually or automatically sent (e g., letter, email, instant messaging, telephone call, facsimile, etc.) to the debtor to inform him that a direct debit is due to be debited on his account. Thus, the financial software of the debtors bank must trigger correspondence to the debtor or designated agent that a direct debit is due.

In embodiments of the present invention, an account holder (debtor is allowed to log on and view his direct debit mandates signed with various partners via his e-banking webpage (or other interface such as a computer system at the bank itself, etc.) The financial software involved allows for the reading the information of the direct debit mandates. In embodiments of the present invention, an account holder may view the direct debit collections due that have not been debited yet via his e-banking webpage (or other interface). The financial software involved allows for the reading of due direct debit collections. In embodiments of the present invention, a bank may have granted an account holder an installment loan. In order to pay the installments each month, the account holder may sign a direct debit mandate where the creditor is the bank, and thus, the bank can request and obtain the agreed payment each month. The financial software involved allows for the creation of a direct debit mandate for a loan debtor. In embodiments of the present invention, mandates may be made automatically invalid after a certain period, and/or after a certain period of not being used. The financial software involved allows for the status check of the direct debit mandate(s).

The network connecting the computer components of a system according to the present invention may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software may be written in any programming language, such as ABAP, C, C++, Java or Visual Basic. In various embodiments, application software embodying the functionality of the present invention may be deployed on a standalone machine or device, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for direct debiting, comprising:
providing a process object, the process object having at least one information describing a direct debit mandate;
communicating the direct debit mandate as a process object to a creditor using the same process object, wherein the process object maintains its direct debit mandate features,
reading the direct debit mandate by the creditor for the description of the direct debit mandate;
requesting a payment from the debtor via direct debit;
validating the requesting the payment with the description of the direct debit mandate; and
implementing a financial software at both a creditor bank and a debtor bank, the financial software having at least one common process object concerning direct debit mandates,
wherein the creditor and debtor banks communicate and exchange payment based on the at least one common process object concerning direct debit mandates.

2. The method of claim 1, wherein the at least one common process object concerning direct debit mandates includes authorization from a debtor to pay a predetermined monetary amount to a creditor.

3. The method of claim 2, wherein the authorization includes a specific date for payment.

4. The method of claim 1, further comprising:
receiving at least one signed mandate from the debtor by the creditor;
initiating the direct debit with the creditor bank by the creditor;
collecting the direct debit from the debtor bank;
requesting information on the direct debit collection from the debtor by the debtor bank.

5. The method of claim 4, wherein the debtor provides a signed direct debit mandate as one of a one-time mandate and a recurrent mandate for each direct debit collection to be made.

6. The method of claim 5, wherein the financial software can effect at least one of a creation of a direct debit mandate, transmission of a direct debit mandate, and cancellation of a direct debit mandate.

7. A method for communicating between banking and non-banking entities, comprising:
receiving by the creditor a signed direct debit mandate from a debtor;
communicating by the creditor the signed direct debit mandate to a bank of the creditor, the bank reading the signed direct debit mandate;
communicating by the bank of the creditor a request for direct debit payment and the direct debit mandate to the bank of the debtor; and
allowing by the bank of the debtor the bank of the creditor to debit from a bank account of the debtor.

8. The method of claim 7, wherein the direct debit mandate is communicated as a software object.

9. The method of claim 8, further comprising:
communicating an unsigned direct debit mandate to a debtor;
signing the direct debit mandate by the debtor; and
communicating the signed direct debit mandate by the debtor to the creditor.

10. The method of claim 9, wherein the creditor stores the unsigned direct debit mandate, communicates the unsigned direct debit mandate to the debtor, and then updates the stored direct debit mandate with the signed direct debit mandate.

11. The method of claim 8, wherein before allowing the bank of the creditor to debit the bank account of the debtor, the bank of the debtor communicates with the debtor to at least one of validate the direct debit mandate, notice the debtor of a withdrawal, notice the debtor of a lack of funds.

12. The method of claim 8, further comprising:
debiting by the creditor bank the bank account of the debtor; and
communicating by the creditor bank the debiting event to the creditor.

13. The method of claim 8, wherein the banks of the creditor and debtor use different software than the debtor and creditor.

14. The method of claim 8, wherein the debtor provides a signed direct debit mandate as one of a one-time mandate and a recurrent mandate.
